(19) United States
(12) Patent Application Publication
(10) Pub. No.: US 2013/0249387 A1
(43) Pub. Date: Sep. 26, 2013

(54) LIGHT-EMITTING DIODES, PACKAGES, AND METHODS OF MAKING

(71) Applicants: Chia-Fen Hsin, New Taipei City (TW); Lu-Ming Lai, Chung-Li City (TW); Ying-Zhong Chen, New Taipei City (TW)

(72) Inventors: Chia-Fen Hsin, New Taipei City (TW); Lu-Ming Lai, Chung-Li City (TW); Ying-Zhong Chen, New Taipei City (TW)

(21) Appl. No.: 13/425,040

(22) Filed: Mar. 20, 2012

(51) Int. Cl. H01J 1/70; H01J 9/00; H01J 1/62

(52) U.S. Cl. 313/512; 313/498; 445/23

(57) ABSTRACT

A light-emitting diode (LED) element including an LED chip having a light emitting surface and at least one pad. A phosphor layer is formed on the light emitting surface and exposes the at least one pad. The phosphor layer includes a plurality of phosphor particles and a matrix. At least some of the phosphor particles have a first portion embedded in the matrix and a second portion protruding from an outer surface of the matrix. A method of forming a gel layer on an LED element includes using capillary action to draw the glue material into a space adjacent the upper surface of the chip.

### BACKGROUND

The present embodiments relate to light-emitting diodes (LEDs), packages including LEDs, and methods of making LED packages.

### DESCRIPTION OF RELATED ART

Light Emitting Diodes (LEDs), or laser diodes, are widely used for many applications. A semiconductor light emitting device includes an LED chip having one or more semiconductor layers. The layers are configured to emit coherent and/or incoherent light when energized. During manufacture, a large number of LED semiconductor dies are produced on a semiconductor wafer. The wafer is probed and tested to accurately identify particular color characteristics of each die, such as color temperature. Then, the wafer is singulated to cut the wafer into a plurality of chips. The LED chips are typically packaged to provide external electrical connections, heat sinking, lenses or waveguides, environmental protection, and/or other features. Conventional methods for making LED chip packages comprise processes such as die attach, wire bonding, encapsulating, testing, etc.

It is often desirable to incorporate a phosphor into the LED package, to enhance the emitted radiation in a particular frequency band and/or to convert at least some of the radiation to another frequency band. Conventionally, phosphors are included during the LED chip packaging process. In one technique, the phosphor may be suspended in the encapsulant provided in the LED package. In an alternative approach, the phosphor may be directly coated on the LED chip, after the steps of die attach and wire bonding, by dispensing or spray coating.

However, in the dispensing method it is difficult to control the thickness of phosphor. Variations in the phosphor thickness create color non-uniformity of the light output from the LED package. The spray coating method provides better thickness control, but is expensive due to phosphor waste, since the phosphor sometimes coats portions of the work piece other than those desired to be coated.

After the phosphor is added, another test may be performed to determine whether the light emission of the packaged LED chip with phosphor conforms to a desired color characteristic, such as color temperature. Any unsatisfactory packages may be discarded or reworked. Reworking typically involves manual removal of excessive phosphor or manual addition of extra phosphor to make up for a phosphor deficiency. Manual processes significantly increase manufacturing costs.

It has been proposed to apply a phosphor coating on a semiconductor LED wafer while exposing each die's bonding pads via a photopatternable film or by stencil printing. However, the photopatternable film requires an expensive photomask. Stencil printing does not allow selectively coating a very thin, typically under 100 μm, phosphor layer, which includes phosphor particles having a diameter of 5-15 μm.

### SUMMARY

The various embodiments of the present light-emitting diodes, packages, and methods of making have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

One aspect of the present embodiments includes the realization that it would be beneficial to have a simple and efficient way to selectively apply a phosphor coating on a semiconductor wafer, while allowing for wafer level color testing before proceeding to singulation and chip packaging.

One of the present embodiments comprises a light-emitting diode (LED) element. The LED element comprises an LED chip having a light emitting surface and at least one pad. The LED element further comprises a phosphor layer formed on the light emitting surface and exposing the at least one pad. The phosphor layer includes a plurality of phosphor particles and a matrix. At least some of the phosphor particles have a first portion embedded in the matrix and a second portion protruding from an outer surface of the matrix.

Another of the present embodiments comprises a light-emitting diode (LED) package. The LED package comprises a substrate and an LED element disposed on the substrate. The LED element comprises an LED chip having a light emitting surface and at least one pad. The LED element further comprises a phosphor layer formed on the light emitting surface and exposing the at least one pad. The phosphor layer includes a plurality of phosphor particles and a matrix. At least some of the phosphor particles have a first portion embedded in the matrix and a second portion protruding from an outer surface of the matrix. The LED package further comprises at least one electrical element electrically connecting the at least one pad of the LED chip to the substrate. The LED package further comprises an encapsulant encapsulating the LED chip and the electrical at least one electrical element.

Another of the present embodiments comprises a method of making a chip having a first surface and a plurality of pads disposed on the first surface. The method comprises providing a temporary substrate including a bonding surface and a plurality of protruding portions on the bonding surface. Locations of the protruding portions on the temporary substrate correspond to locations of the pads on the first surface of the chip. The method further comprises forming an adhesive layer on each of the protruding portions. The method further comprises bonding the temporary substrate to the chip such that the protruding portions are connected to respective ones of the pads via the adhesive layers. The bonding surface of the temporary substrate faces the first surface of the chip and a dispensing space is formed between the bonding surface and the first surface. The method further comprises filling the dispensing space with a glue to form a gel layer encapsulating the pads, the protruding portions. and the adhesive layers. The method further comprises removing the temporary substrate to separate the protruding portions and the adhesive layers from the pads to form a plurality of openings in the gel layer, the openings exposing respective ones of the pads.

### BRIEF DESCRIPTION OF THE DRAWINGS

FIG. 4 is a cross-sectional side view of an LED package according to the present embodiments;

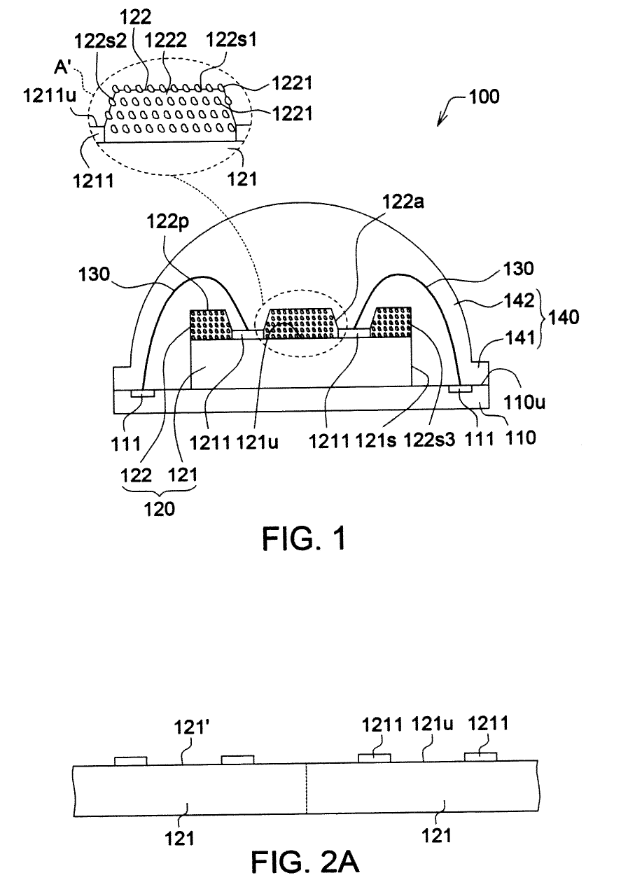

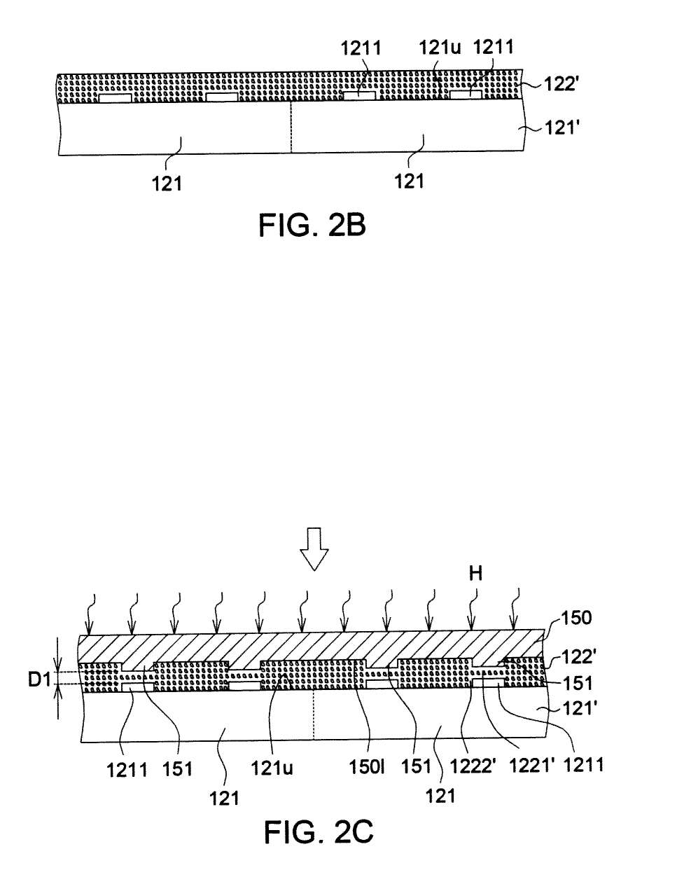

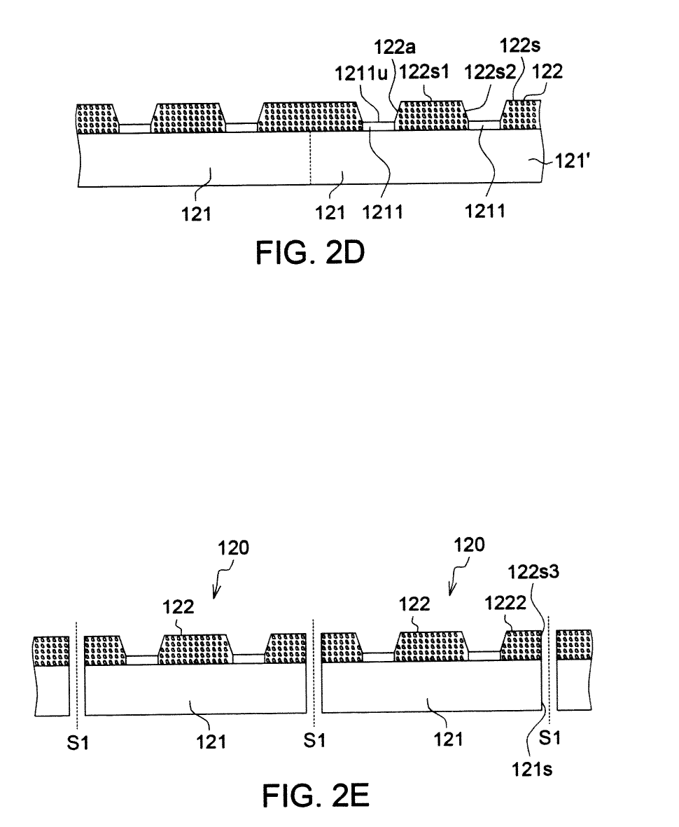

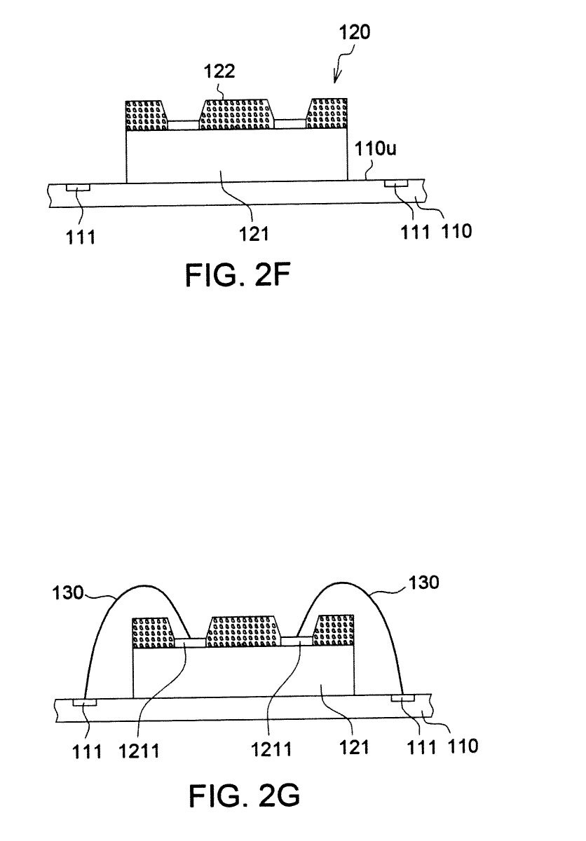

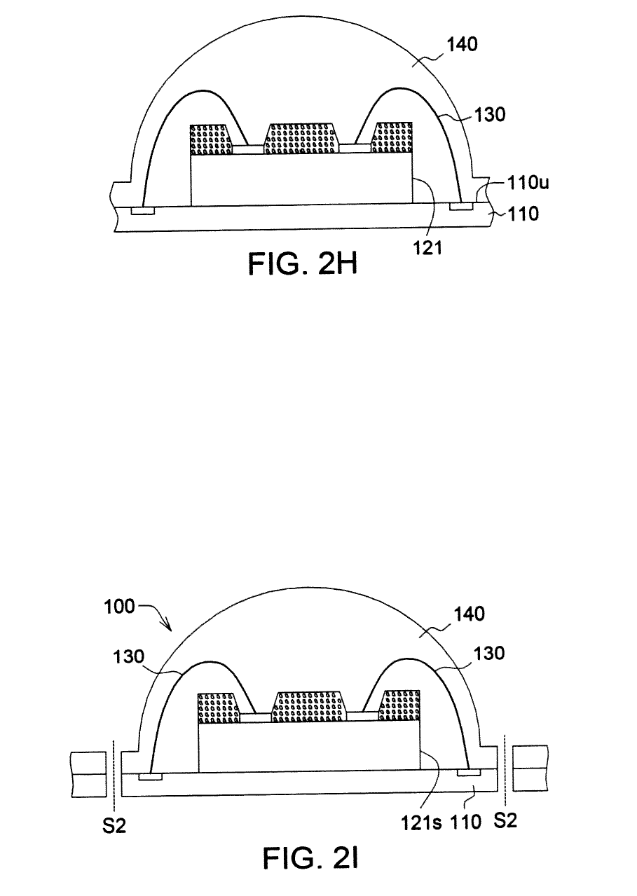

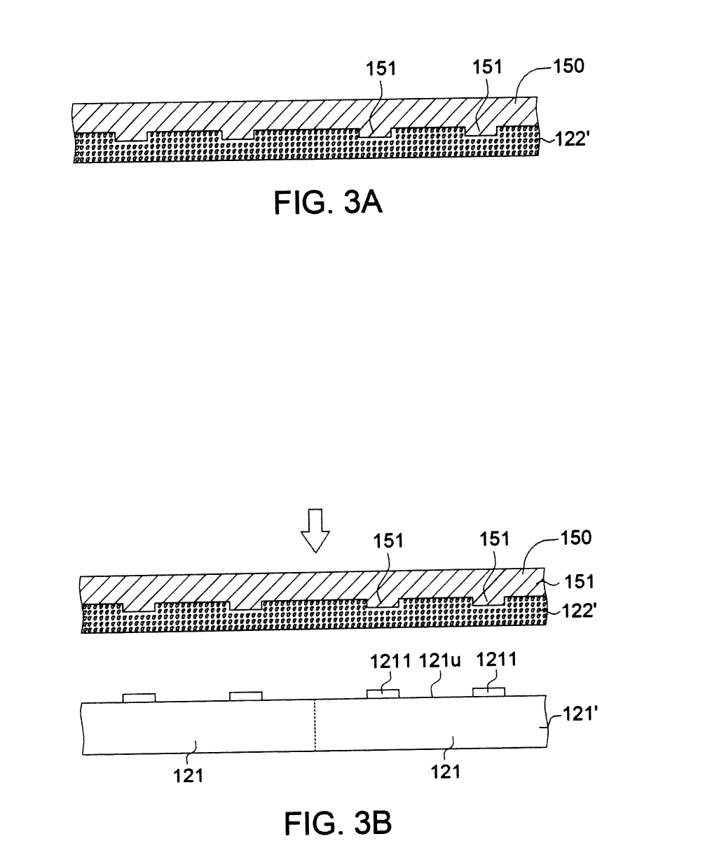

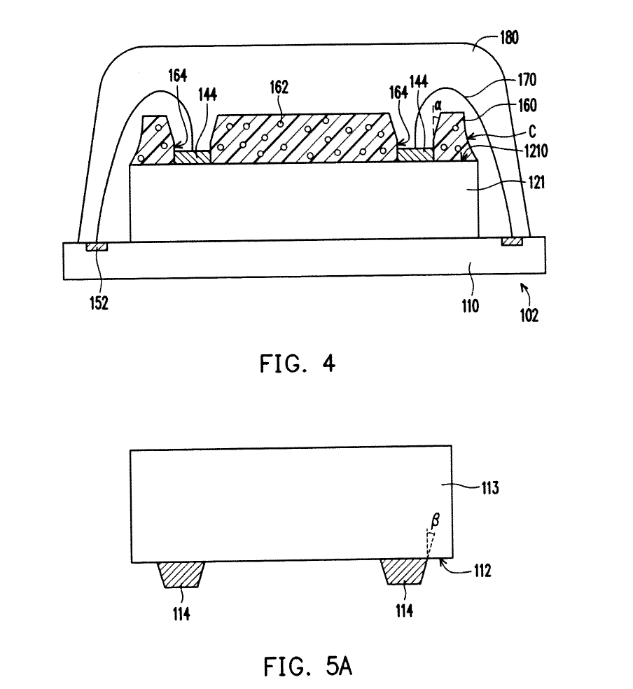

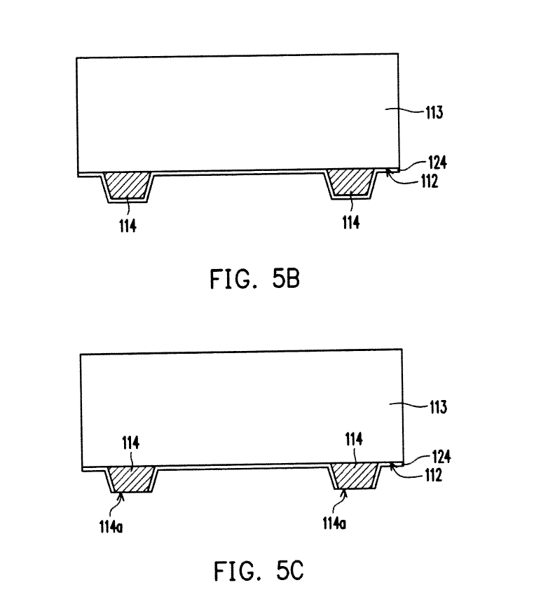

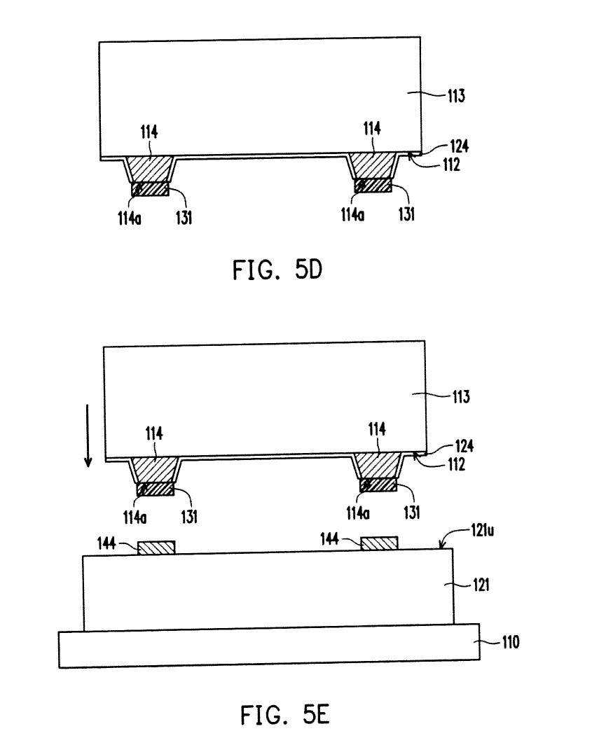

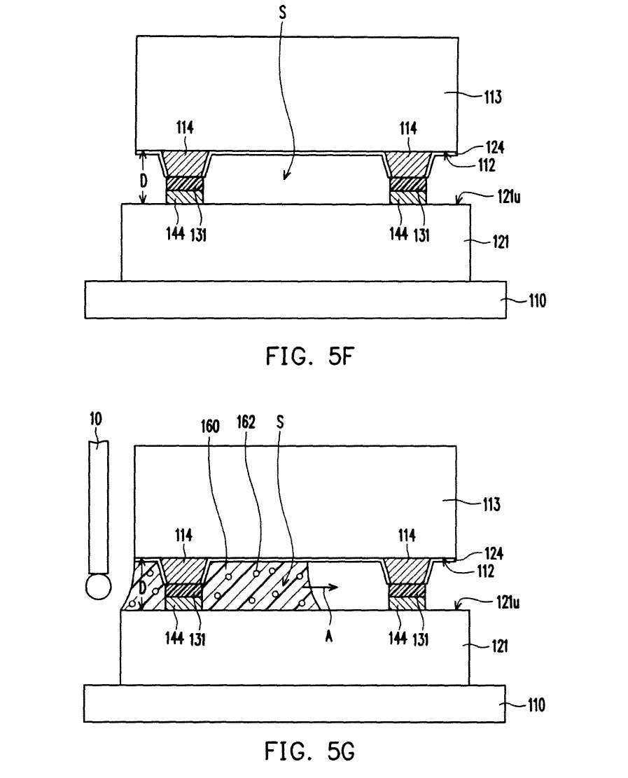

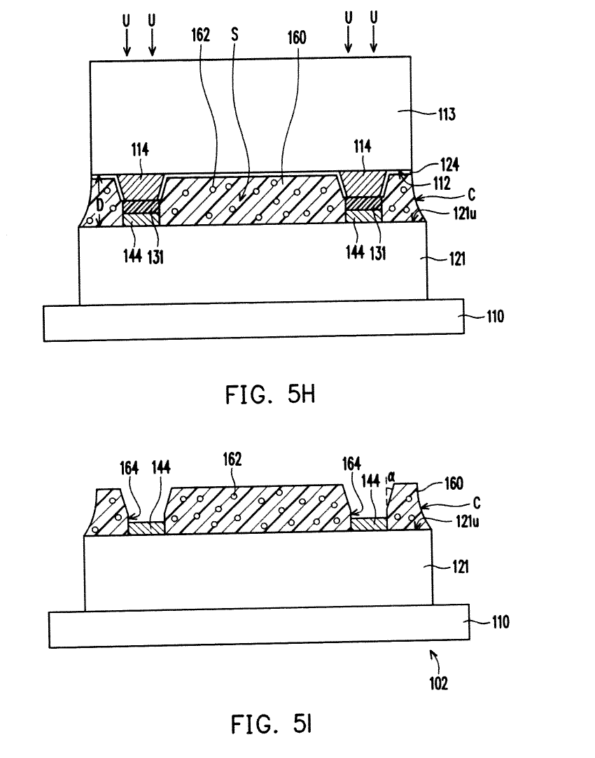

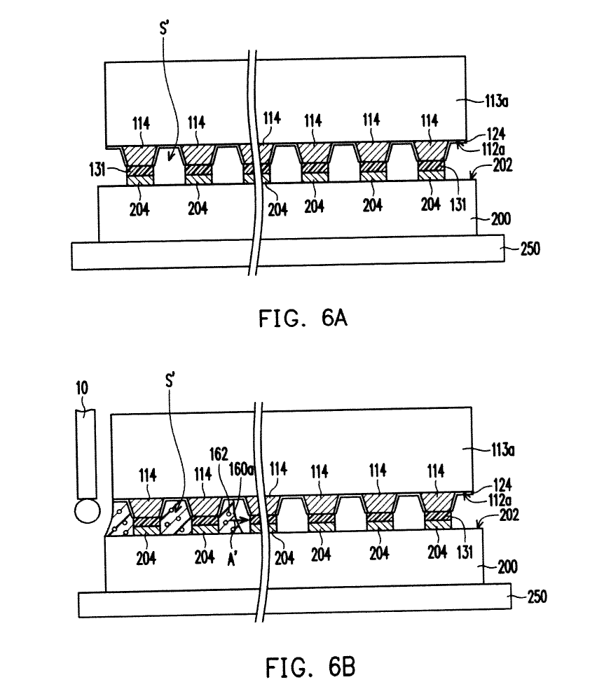

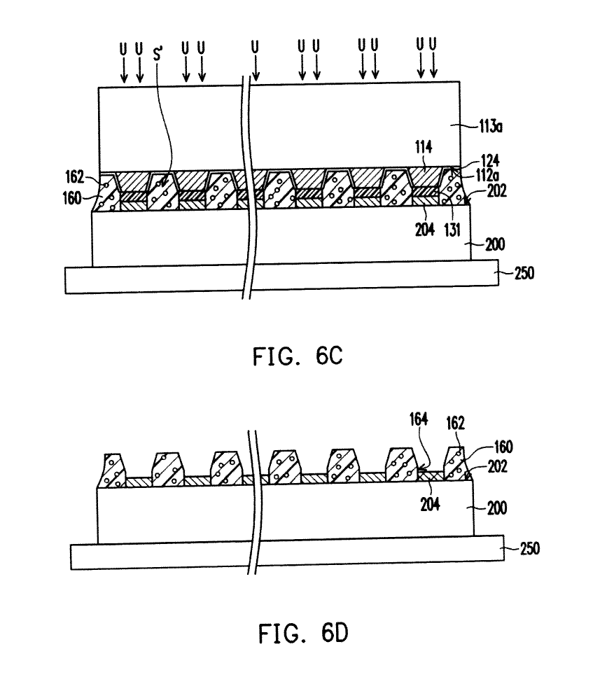

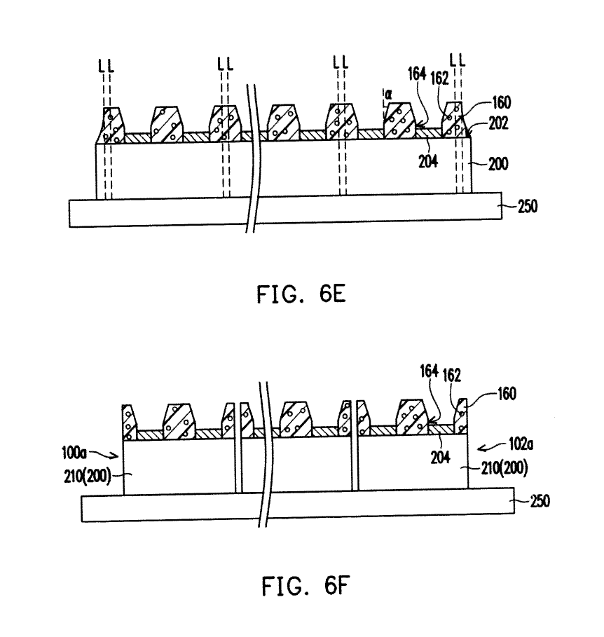

FIGS. 2A-2I are schematic cross-sectional views illustrating steps in one embodiment of a method of making the LED package of FIG. 4;

FIGS. 3A and 3B are schematic cross-sectional views illustrating steps in a method of making a phosphor layer according to the present embodiments;

FIG. 4 is a cross-sectional side view of another LED package according to the present embodiments;

FIGS. 5A-5I are schematic cross-sectional views illustrating steps in a dispensing method according to the present embodiments; and

FIGS. 6A-6F are schematic cross-sectional views illustrating steps in another dispensing method according to the present embodiments.

Common reference numerals are used throughout the drawings and the detailed description to indicate the same elements. The present invention will be more apparent from the following detailed description taken in conjunction with the accompanying drawings.

### DETAILED DESCRIPTION

Referring to FIG. 1, a cross-sectional view of a light-emitting diode (LED) package according to one of the present embodiments is illustrated. The LED package 100 includes a substrate 110, an LED element 120, a plurality of electrical elements 130, and an encapsulant 140. The LED element 120 comprises an LED chip 121 and a phosphor layer 122.

The LED chip 121 can comprise a light-emitting diode, a laser diode, or another device that may include one or more semiconductor layers. The semiconductor layers may comprise silicon, silicon carbide, gallium nitride, or any other semiconductor materials. The LED chip 121 may further comprise a substrate (not shown), which may be sapphire, silicon, silicon carbide, gallium nitride, or any other material. The LED chip 121 may further comprise one or more contact layers (not shown), which may comprise metal or any other conductive material.

The substrate 110 comprises an upper surface 110u having at least one electrical contact 111. The substrate may be a silicon interposer, a ceramic substrate. a printed circuit board, or any other type of substrate. The electrical contacts 111 may be pads, or any other type of contacts.

The LED chip 121 is disposed on the upper surface 110u of the substrate 110. In the illustrated embodiment, the LED chip 121 is disposed on the substrate 110 in a face-up manner and electrically connected to the substrate 110 with wires 130. The LED chip 121 has a light-emitting surface 121u, and comprises a plurality of pads 1211, each having an upper surface 1211u (inset A′ in FIG. 1).

The phosphor layer 122 is formed on the light emitting surface 121u. The phosphor layer 122 has a plurality of cavities 122a that expose a plurality of pads 1211. In the illustrated embodiment, the phosphor layer 122 projects above upper surfaces 1211u of the pads 1211 (detail view A′ of FIG. 1). The phosphor layer 122 comprises a plurality of phosphor particles 1221 suspended in a matrix 1222. Materials for the matrix maybe transparent resins such as transparent silicone. Preferably, the phosphor particles 1221 are substantially uniformly distributed in the matrix 1222, so that the LED package 100 has excellent color consistency.

Many of the phosphor particles 1221 are completely embedded in the matrix 1222. However, as illustrated in A′ of FIG. 1, some phosphor particles 1221 located on an outer periphery of the matrix 1222 are only partially embedded. These partially embedded phosphor particles 1221 have a portion embedded in the matrix 1222 and another portion protruding from an outer surface 122s of the matrix 1222, thereby giving the outer surface 122s a rough texture which, in certain package types (such as air cavity package) having only air or gas filled between the phosphor layer and the light output surface (such as a transparent cover's surface), can increase the overall light-emitting efficiency by reducing the internal reflection on the interface between the phosphor layer and the air or gas.

The phosphor particles 1221 may enhance the LED chip 121's emitted radiation in a particular frequency band and/or convert at least some of the emitted radiation to another frequency band. In one embodiment, the LED chip 121 may emit blue light and the phosphor particles 1221 may comprise Cerium doped Yttrium Aluminum Garnet (YAG:Ce) (e.g., (YGdTb)₃(AlGa)₅O₁₂:Ce) which can convert part of the blue light into yellow light, producing white light.

Alternatively, the phosphor particles 1221 may comprise (SrBaCaMg)₂SiO₄:Eu, (Sr,Ba,CaMg)₃SiO₅:Eu, CaAlSiN₃:Eu, CaScO₄:Ce, Ca₁₀(PO₄)FCl:SbMn, M₅(PO₄)₃Cl:Eu, BaBg₂Al₁₆O₂₇:Eu, Ba, MgAl₁₆O₂₇:Eu, Mn, 3.5 MgO.0.5 MgF₂.GeO₂:Mn, Y₂O₂S:Eu, Mg₆As₂O₁₁:Mn, Sr₄Al₁₄O₂₅:Eu, (Zn,Cd)S:Cu, SrAl₂O₄:Eu, Ca₁₀(PO₄)₆ClBr:Mn, Eu, Zn₂GeO₄:Mn, Gd₂O₂S:Eu or La₂O₂S:Eu, wherein, M is an alkali earth metal, e.g., Sr, Ca, Ba, Mg, or a combination thereof In certain embodiments, sizes of the phosphor particles 1221 may range between about 5-20 μm.

With reference to the detail view A′ of FIG. 1, the outer surface of the phosphor layer 122 comprises an upper surface 122s1 and a lateral surface 122s2 extending between the upper surface 122s1 and the pads 1211. In the illustrated embodiment, the lateral surface 122s2 is inclined, such that each cavity 122a has a top opening in the upper surface 122s1 and the top opening is larger than the corresponding pad's surface. In other embodiments, the lateral surface 122s2 could be vertical so that the width of each cavity 122a is constant over its height.

With reference to FIG. 1, a peripheral portion 122p of the phosphor layer 122 has a first lateral edge surface 122s3, and the LED chip 121 has a second lateral edge surface 121s. The first lateral edge surface 122s3 and the second lateral edge surface 121s together define the edge surface of the LED chip 121. In the illustrated embodiment, the first lateral edge surface 122s3 and the second lateral edge surface 121s are coplanar, but in other embodiments they may not be.

With continued reference to FIG. 1, the encapsulant 140 encapsulates the LED chip 121 and the electrical elements 130. The encapsulant 140 comprises a first portion 141 and a second portion 142. The first portion 141 covers a periphery of the upper surface 110u of the substrate 110, and is shaped as a ring. The second portion 142 extends inward and upward from the first portion 141, and is shaped as a dome. In other embodiments, the first and second portions 141, 142 could have other shapes. In particular, the second portion 142 could be angular.

The matrix 1222 and the encapsulant 140 may be the same material or different materials. For example, one or both may be a transparent polymer or translucent polymer, such as epoxy-based resin, a mixture thereof or any other suitable encapsulating agent. In one embodiment, the matrix 1222 or the encapsulant 140 may comprise an organic filler or an inorganic filler, such as, SiO₂, TiO₂, Al₂O₃, Y₂O₃, carbon black, sintered diamond powder, asbestos, glass, or a combination thereof.

A method of making a phosphor layer according to one of the present embodiments is described below with reference to FIGS. 2A-2E. FIG. 2A illustrates an LED wafer 121′ including a plurality of non-singulated LED chips 121. Each chip 121 includes the upper light emitting surface 121u and at least one of the pads 1211. As illustrated in FIG. 2B, a phosphor material 122″ is formed over the light emitting surface 121u and the pads 1211 of each LED chip 121. The phosphor material 122″ may be formed by dispensing or printing, for example, or by any other technique.

Then, with reference to FIG. 2C, the phosphor material 122′ is stamped with a micro-imprint mold 150 to form a stamping pattern. Specifically, the micro-imprint mold 150 comprises a plurality of protrusions 151 projecting from its lower surface 1501. Positions of the protrusions 151 correspond to positions of the pads 1211. After stamping, a thickness D1 of first portions 1221′ of the phosphor material 122′ between the protrusions 151 and the pads 1211 is less than a thickness of second portions 1222′ positioned laterally of the pads 1211. Thus, in a subsequent etching process, and without the need for a mask, the first portions 1221′ of the phosphor material 122′ can be completely removed while the second portions 1222′ remain. This etching process is discussed further below with respect to FIG. 2D.

In one embodiment, the phosphor material 122′ may be cured during the stamping process to avoid sedimentation of the phosphor particles 1221 in the phosphor material 122 which, in turn, results in a non-uniform distribution of the phosphor particles 1221 in the phosphor material 122′. As discussed above, a uniform distribution of the phosphor particles 1221 in the phosphor material 122′ facilitates the light emitting color of the LED package 100 falling within the expected bin of the CIE coordinate system.

The phosphor material 122′ may be cured by any technique, such as heating the micro-imprint mold 150 to generate heat H transferred to the phosphor material 122 via the micro-imprint mold 150. Alternatively, the micro-imprint mold 150 may comprise a heating element (not illustrated), which provides the heat to the phosphor material 122′.

With reference to FIG. 2D, an etching process removes the first portions 1221′ (FIG. 2C) of the phosphor material 122′. This etching process may be performed without a mask over the second portions 1222′ (FIG. 2C). Even without a mask, the first portions 1221′ are completely removed to form the cavities 122a that expose the pads 1211, while the second portions 1222′ remain on the LED wafer 121′. Referring back to FIG. 2C, this result is due to the thickness Dl of the second portions 1222′ being larger than that of the first portions 1221′. Performing etching without a mask lowers manufacturing costs, because a mask need not be prepared.

In certain embodiments, the step of removing the first portions 1221′ may include an etching process and a residual particles cleaning process. The etching process may be a reactive ion etching (RIE) process. In some embodiments, the phosphor material 122′ may be etched by a wet etching process or other suitable etching process. In addition, a plasma atmosphere adopted in certain etching processes may be oxygen mixed with trifluoromethane (O₂+CHF₃) or oxygen mixed with tetrafluoromethane (OH₂+CF₄). A residual particles cleaning process may comprise washing the phosphor layer 122 with, for example, deionized water, to remove any detached phosphor particles 1221 and any residual etching agent.

With reference to FIG. 1A′, in the etching process the matrix material 1222′ at the outermost extent of the phosphor material 122′ is removed, such that some phosphor particles 1221 become partially exposed. The partially exposed phosphor particles 1221 form the rough outer surface 122s described above. The outer surface 122s may achieve different degrees of roughness by controlling the proportions of plasma gases in the etching process, for example.

As discussed above, the lateral surface 122s2 of the phosphor material 122′ may be inclined or sloped after being etched, but could instead be substantially perpendicular to the upper surface 1211u of the pads 1211. By properly controlling the manufacturing process, or adopting other etching process(es), the lateral surface 122s2 of the phosphor material 122′ can be given any desired orientation.

With reference to FIG. 2E, the LED wafer 121′ and the phosphor layer 122 are singulated to form a plurality of LED elements 120 having a phosphor layer 122 formed on an LED chip 121. The slits S1 generated by the singulation process form the first lateral edge surface 122s3 of the matrix 1222, and the second lateral edge surface 121s of the LED chip 121. Again, the surfaces 122s3, 121s are substantially coplanar. In certain embodiments, the slits S1 may be formed by a laser or a cutting tool.

Note that, before conducting the singulation step, the wafer 121′ shown in FIG. 2D is probed and tested to accurately identify each die's color characteristic. Typically, a color chart is used to associates two parameters (X and Y) with the color characteristic, i.e., the color temperature and a number of bins each including a range of X and Y values are defined in the color chart. The color chart provides a mechanism by which the X and Y values can be used to accurately identify particular colors for the purpose of binning and sorting the dies with phosphor coating thereon as described here. During the probing process, a probing device includes contacts points that are positioned to touch the pads 1211 of each die. The pads 1211 are exposed and accessible through the cavities 122a. Once the dies are energized, the probing device measures color temperature, lumen output, voltage, current, and any other operating parameters associated with each die. In an aspect, the measured parameters for each die are mapped to X and Y values based on the color chart. Thus, each die is associated with its own X and Y values prior to singulation. Thus, as each die is separate from the wafer during the singulation process, its associated X and Y value can be used to sort it into the appropriate bin. The dies with phosphor coating thereon in each bin can then be packaged using any packaging method to produce LED packages having excellent color consistency.

A method of packaging an LED chip 121 having a phosphor layer 122 according to one of the present embodiments is described below with reference to FIGS. 2F-2I. With reference to FIG. 2F, an LED chip 121 having a phosphor layer 122 is disposed on a substrate 110. The substrate 110 comprises a plurality of electrical contacts 111, such as pads. With reference to FIG. 2G, the pads 1211 of the LED chip 121 and the electrical contacts 111 of the substrate 110 are electrically connected by a plurality of electrical elements 130. In this embodiment, the LED chip 121 is disposed on the substrate 110 in a face-up orientation, and the electrical elements 130, which may be solder wires, for example, connect the LED chip 121 and the substrate 110.

With reference to FIG. 2H, the LED chip 121 and the electrical elements 130 are encapsulated by an encapsulant 140, which also covers the upper surface 110u of the substrate 110. With reference to FIG. 21, slits S2 are formed passing through the encapsulant 140 and the substrate 110 to form a plurality of the LED packages 100 illustrated in FIG. 1. In certain embodiments, the slits S1 may be formed by a laser or a cutting tool.

In the above embodiment, the phosphor material 122′ (FIG. 2B) is formed on the LED wafer 121′ before the stamping process is performed (FIG. 2C). However, the phosphor material 122′ may be formed on the micro-imprint mold 150 before the stamping process is performed, as described below.

A method of making a phosphor layer according to another of the present embodiments is described below with reference to FIGS. 3A and 3B. With reference to FIG. 3A, the phosphor material 122′ may be directly formed on the micro-imprint mold 150 such that the phosphor material 122′ covers the protrusions 151. With reference to FIG. 3B, the phosphor material 122′ is then stamped onto the light emitting surface 121u of the LED chip 121 with the micro-imprint mold 150. In this embodiment, the phosphor layer may thus be formed by transfer printing.

Referring to FIG. 4, a cross-sectional view of a light-emitting diode (LED) package 102 according to another of the present embodiments is illustrated. The package 102 includes an LED chip 121 disposed on a substrate 110, and a gel layer 160 disposed on the LED chip 121. The substrate may be, for example, a silicon substrate, a ceramic substrate or a printed circuit board.

The LED chip 121 includes a first, light-emitting surface 121u and a plurality of bonding pads 144 disposed on the first surface 121u. The bonding pads 144 of the LED chip 121 are connected to the substrate's pads 152 via electrical components 170, such as bonding wires. The gel layer 160 covers the first surface 121u, and includes a plurality of openings 164 exposing respective ones of the bonding pads 144. Each opening 164 includes a draft angle α, which results from the removal of a mold during a process of making the package 102, as described below. The draft angle α may be between about 3° and about 20° to facilitate easy removal of the mold while preserving a substantially uniform thickness of the gel layer 160. In certain embodiments, the draft angle α may be between about 5° and about 10°.

Materials for forming the gel layer 160 include, without limitation, transparent resins, such as transparent silicone. In addition, the gel layer 160 may include a plurality of phosphor particles 162. The diameter of the phosphor particles 162 may be between about 5 μm and about 20 μm. The phosphor particles 162 may enhance the LED chip's emitted radiation in a particular frequency band and/or convert at least some of the emitted radiation to another frequency band. Materials for forming the phosphor particles 162 may comprise any of those described above with reference to the phosphor particles 1221, or other materials.

With further reference to FIG. 4, an encapsulant 180 encapsulates the LED chip 121 and the electrical components 170. The illustrated profile shape of the encapsulant 180 is only one example, and could be any shape. The encapsulant 180 may comprise transparent polymers or translucent polymers, such as glass cement, elastomer or resins, wherein resins comprises epoxy-based resins, silicone-based resins, mixtures of epoxy-based resins and silicone-based resins, or other materials. In certain embodiments, the encapsulant 180 may be mixed with organic or inorganic fillers, such as silicon dioxide, titanium dioxide, aluminum oxide, iridium oxide, carbon black, sintered diamond powder, asbestos, glass, and/or combinations thereof.

A method of forming the gel layer 160 on the LED chip 121 according to one of the present embodiments is described below with reference to FIGS. 5A-5I. FIG. 5A illustrates a temporary substrate 113. The temporary substrate includes a bonding surface 112 and a plurality of protruding portions 114 (only two shown in FIG. 5A) located on the bonding surface. In this embodiment, the side wall of each protruding portion 114 has a slant angle β which may be between about 2° and about 19°. In certain embodiments, the slant angle β may be between about 4° and about 9°. The material of the protruding portions 114 may be, for example, a metal.

With reference to FIG. 5B, a release layer 124 is provided on the temporary substrate 113. The release layer covers the bonding surface 112 and the protruding portions 114 and facilitates easy removal of the temporary substrate 113 later in the present process. The release layer 124, which may comprise fluoropolymers, for example, may be formed by spraying or dipping, for example.

With reference to FIG. 5C, portions of the release layer 124 that cover a bonding area 114a of each bump 114 are removed to expose the bonding areas 114a. Then, with reference to FIG. 5D, an adhesive layer 131 is formed on the bonding area 114a of each of the protruding portions 114. The adhesive layers 131 may be, for example, an ultraviolet-curable adhesive or a double-sided tape. In order to facilitate removal of the temporary substrate 113, the bond strength of the ultraviolet-curable adhesive can be reduced by UV curing prior to removing the temporary substrate 113. The double-sided tape may have greater bond strength on a first side that adheres to the temporary substrate 113 than on a second side that adheres to the protruding portions 114.

Next, with reference to FIG. 5E, the temporary substrate 113 is located above the LED chip 121 disposed on the substrate 110. This step may be performed by a pick and place machine, for example. The protruding portions 114 of the temporary substrate 113 are located at positions corresponding to locations of the bonding pads 144 of the LED chip 121.

Next, with reference to FIG. 5F, the temporary substrate 113 is bonded to the LED chip 121, so that the protruding portions 114 are connected to respective ones of the bonding pads 144 of the LED chip 121 via the adhesive layers 131. At this point, the bonding surface 112 of the temporary substrate 113 faces the first surface 121 u of the LED chip 121, and a dispensing space S is formed between the bonding surface 112 and the first surface 121u. If the adhesive layers 131 are double-sided tape, the bond strength between the double-sided tape and the protruding portions 114 of the temporary substrate 113 is preferably greater than the bond strength between the double-sided tape and the bonding pads 144 of the LED chip 121. In certain embodiments, a distance D between the bonding surface 112 of the temporary substrate 113 and the first surface 121u of the LED chip 121 is, for example, greater than 50 μm and less than 100 μm.

Next, with reference to FIGS. 5G and 5H, the dispensing space S is filled with a glue 160a. The temporary substrate 113 together with the protruding portions 114 and the adhesive layers 131 acts as a mold to shape the filled glue such that no glue comes into contact with the bonding pads 144, thereby facilitating high-quality wire bonds (described below). The glue 160a can be provided by a dispenser 10 or a nozzle (not shown) to an edge of the dispensing space S. Due to the small gap between the bonding surface 112 of the temporary substrate 113 and the first surface 121u of the LED chip 121, capillary action draws the glue 160a into the dispensing space S in the direction of the arrow A. A viscosity of the glue 160a may be between about 3,000 cP and 20,000 cP.

Subsequently, with reference to FIGS. 5H and 5I, the temporary substrate 113 together with the protruding portions 114 and the adhesive layers 131 are separated from the bonding pads 144, thereby forming a plurality of openings 164 in the gel layer 160. The presence of the release layer 124 on the temporary substrate 113 facilitates easier separation of the protruding portions 114 and the adhesive layers 131 from the bonding pads 144. If the adhesive layers 131 are ultraviolet-curable adhesives. UV irradiation may be applied to the adhesive layers 131 before removing the temporary substrate 110 to reduce the bond strength between the adhesive layers 131 and the bonding pads 144.

After filling the dispensing space S, the glue 160a is cured to form the gel layer 160. The curing process may comprise a pre-curing step performed when the temporary substrate 113 is attached to the chip 121 and a post-curing step performed after the temporary substrate 113 is separated from the chip 121. The curing process may be performed by any technique, such as using a heating element (not illustrated) to provide the heat to the glue 160a.

The openings 164 expose respective ones of the bonding pads 144 of the LED chip 121. The draft angle α of each opening 164 is slightly larger than the slant angle β of the side wall of the corresponding bump 114 since the glue 160a contracts slightly during the curing process. At this point, the dispensing method has formed the gel layer 160 on the LED chip 121.

In the present embodiments, since a substantially constant distance D separates the bonding surface 112 of the temporary substrate and the first surface 121u of the LED chip 121, the thickness of the gel layer 160 can be closely controlled. Furthermore, since the Gel layer 160 can be easily confined in the gap between the bonding surface 112 and the first surface 121u, little if any glue material 160a is wasted. In conventional spray-coating methods, a large quantity of glue is wasted, since it is deposited on the substrate in addition to the LED chip.

With reference to FIG. 6A, any or all of the steps of the foregoing dispensing method can be performed on a wafer 200 including a plurality of chips 210. For example, FIG. 6A illustrates a temporary substrate 113a, which is, for example, a wafer level substrate corresponding to the wafer 200. The temporary substrate 113a includes a bonding surface 112a and a plurality of protruding portions 114 located on the bonding surface 112a. An adhesive layer 131 is formed on a bonding area 114a of each of the protruding portions 114. Next, the temporary substrate 113a is bonded to the wafer 200 disposed on a carrying board 250, so that the protruding portions 114 connect to respective ones of the pads 204 of the wafer 200 via the adhesive layers 131. At this point, the bonding surface 112a of the temporary substrate 113a faces the top surface 202 of the wafer 200, and a dispensing space S′ is formed between the bonding surface 112a and the top surface 202. Next, with reference to FIGS. 6B and 6C, the dispensing space S′ is filled with a glue 160a. The glue 160a can be provided by a dispenser 10 or a nozzle (not shown) to an edge of the dispensing space S. Due to the small gap between the bonding surface 112a of the temporary substrate 113a and the top surface 202 of the wafer 200, capillary action draws the glue 160a into the dispensing space S′ in the direction of the arrow A to form the gel layer 160. The gel layer 160 encapsulates the pads 204, the protruding portions 114, and the adhesive layers 131. In addition, the glue 160a can include a plurality of phosphor particles 162.

Subsequently, with reference to FIGS. 6C and 6D, the temporary substrate 113a is removed, so that the protruding portions 114 and the adhesive layers 131 are separated from the pads 204 to form a plurality of openings 164 in the gel layer 160. The openings 164 expose respective ones of the pads 204 of the wafer 200. Next, with reference to FIG. 6E, after removing the temporary substrate 113a, the wafer 200 and the gel layer 160 are cut along the line L, to form independent chips 210. With reference to FIG. 6F, a side wall of the gel layer 160 and a side wall of the chips 210 are substantially coplanar. At this point, the gel layer 160 has been formed on the wafer 200 that includes multiple chips 210.

While the invention has been described and illustrated with reference to specific embodiments thereof, these descriptions and illustrations do not limit the invention. It should be understood by those skilled in the art that various changes may be made and equivalents may be substituted without departing from the true spirit and scope of the invention as defined by the appended claims. The illustrations may not necessarily be drawn to scale. There may be distinctions between the artistic renditions in the present disclosure and the actual apparatus due to manufacturing processes and tolerances. There may be other embodiments of the present invention which are not specifically illustrated. The specification and the drawings are to be regarded as illustrative rather than restrictive. Modifications may be made to adapt a particular situation, material, composition of matter, method, or process to the objective, spirit and scope of the invention. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. A light-emitting diode (LED) element, comprising:
an LED chip having a light emitting surface and at least one pad; and
a phosphor layer formed on the light emitting surface and exposing the at least one pad, the phosphor layer including a plurality of phosphor particles and a matrix, wherein at least some of the phosphor particles have a first portion embedded in the matrix and a second portion protruding from an outer surface of the matrix.

2. The LED element of claim 1, wherein the at least one pad has an upper surface, and the phosphor layer projects above the upper surface of the at least one pad.

3. The LED element of claim 2, wherein the outer surface of the matrix comprises an upper surface and an inclined lateral surface extending between the upper surface and the at least one pad.

4. The LED element of claim 1, wherein the matrix has a first lateral edge surface, the LED chip has a second lateral edge surface, and the first lateral edge surface and the second lateral edge surface are substantially coplanar.

5. A light-emitting diode (LED) package, comprising:
a substrate;
an LED element disposed on the substrate, the LED element comprising
an LED chip having a light emitting surface and at least one pad; and
a phosphor layer formed on the light emitting surface and exposing the at least one pad, the phosphor layer including a plurality of phosphor particles and a matrix, wherein at least some of the phosphor particles have a first portion embedded in the matrix and a second portion protruding from an outer surface of the matrix;
at least one electrical element electrically connecting the at least one pad of the LED chip to the substrate; and
an encapsulant encapsulating the LED chip and the electrical at least one electrical element.

6. The LED package of claim 5, wherein the at least one pad has an upper surface, and the phosphor layer projects above the upper surface of the at least one pad.

7. The LED package of claim 6, wherein the outer surface of the matrix comprises an upper surface and an inclined lateral surface extending between the upper surface and the at least one pad.

8. The LED package of claim 5, wherein the matrix has a first lateral edge surface, the LED chip has a second lateral edge surface, and the first lateral edge surface and the second lateral edge surface are substantially coplanar.

9. A method of making a chip having a first surface and a plurality of pads disposed on the first surface, the method comprising:
providing a temporary substrate including a bonding surface and a plurality of protruding portions on the bonding surface, locations of the protruding portions on the temporary substrate corresponding to locations of the pads on the first surface of the chip:
forming an adhesive layer on each of the protruding portions;
bonding the temporary substrate to the chip such that the protruding portions are connected to respective ones of the pads via the adhesive layers, wherein the bonding surface of the temporary substrate faces the first surface of the chip and a dispensing space is formed between the bonding surface and the first surface;
filling the dispensing space with a glue to form a gel layer encapsulating the pads, the protruding portions, and the adhesive layers; and
removing the temporary substrate to separate the protruding portions and the adhesive layers from the pads to form a plurality of openings in the gel layer, the openings exposing respective ones of the pads.

10. The method of claim 9, wherein before forming the adhesive layers on each of the protruding portions, the method further comprises:
forming a release layer on the bonding surface of the temporary substrate, the release layer covering the protruding portions; and
removing the release layer from a bonding area of each bump to expose the bonding area of each bump, wherein the adhesive layers are subsequently formed on the bonding areas of the protruding portions.

11. The method of claim 10, wherein the release layer comprises a fluoropolymer.

12. The method of claim 9, wherein the adhesive layer comprises an ultraviolet-curable adhesive.

13. The method of claim 12, wherein before removing the temporary substrate, the dispensing method further comprises irradiating the ultraviolet curable adhesive with ultraviolet light to cure the adhesive and reduce a bonding strength between the adhesive and the pads.

14. The method of claim 9, wherein the adhesive layer comprises double-sided tape, and a bonding strength between the double-sided tape and the protruding portions is greater than a bonding strength between the double-sided tape and the pads.

15. The method of claim 9, wherein the step of filling the dispensing space comprises positioning the glue at an edge of the dispensing space and allowing the glue to flow into the dispensing space through capillary action.

16. The method of claim 9, wherein the chip is a light-emitting diode (LED) chip, and the glue includes a plurality of phosphor particles.

17. The method of claim 17, wherein at least some of the phosphor particles have a first portion embedded in the glue and a second portion protruding from an outer surface of the glue.

18. The method of claim 17, wherein an outer diameter of the phosphor particles is between 5 μm and 20 μm.

19. The method of claim 9, wherein the steps are performed on a wafer including the chip.

20. The method of claim 19, wherein, after removing the temporary substrate, further comprising cutting the wafer and the gel layer to form the chip, wherein a side wall of the chip and a side wall of the gel layer are substantially coplanar.
